(19) United States
(12) Patent Application Publication
(10) Pub. No.: US 2022/0122181 A1
(43) Pub. Date: Apr. 21, 2022

(54) PROCESSES AND PROCEDURES FOR MANAGING AND CHARACTERIZING LIQUIDITY RISK OF A PORTFOLIO OVER TIME USING DATA ANALYTICS METHODS IN A CLOUD COMPUTING ENVIRONMENT

(71) Applicant: Michael William Kotarinos, Palm Harbor, FL (US)

(72) Inventor: Michael William Kotarinos, Palm Harbor, FL (US)

(21) Appl. No.: 17/076,176

(22) Filed: Oct. 21, 2020

(51) Int. Cl. G06Q 40/06; G06Q 40/08; G06F 16/248; G06N 20/00; G06N 5/04

(52) U.S. Cl. CPC G06Q 40/06; G06Q 40/08; G06F 3/14; G06N 20/00; G06N 5/04; G06F 16/248

(57) ABSTRACT

A business process is presented to construct a system for analyzing liquidity preferences, recommending a portfolio of assets, and recommending steps to rebalance a portfolio. Initial preferences over assets are elicited from a user, which are used to construct a universe of potential assets. An initial portfolio passes through an analytics process that uses decision theory, machine learning and time-series econometrics to characterize the relationship between assets in the universe of potential assets and assets in the initial portfolio. Liquidity structures among these assets are characterized across time, and a Markov Chain Monte Carlo based search process is run across these assets. Data analytics is used to further characterize the results of this search process, and the results are presented to the client via a user interface system. Analytical tools allow the user to further customize portfolio options and explore the nature of these portfolios and the unique risks and opportunities the portfolios present. Once the user settles on a portfolio, a set of rebalancing steps and instructions are provided to rebalance the user's holdings and achieve the desired allocation.

### FIELD OF THE INVENTION

The present invention is generally directed to the analysis and characterization of liquidity risk, where liquidity relates to the ability to consolidate a group of assets of a portfolio into single asset or convert the portfolio to another group of assets. Specifically, the invention provides the asset manager with a suite of tools to understand and visualize the nuanced nature of liquidity fundamental risk over time and a system to manage portfolios with these tools.

### BACKGROUND OF THE INVENTION AND DESCRIPTION OF THE RELATED ART

Liquidity of a person's assets is one of the significant areas of concern when analyzing investments and overall portfolio structure for major financial institutions and institutional investors (Lagos, Ricardo, Guillaume Rocheteau, and Randall Wright. “Liquidity: A New Monetarist Perspective.” Journal of Economic Literature 55.2 (2017): 371-440.). Liquidity is a measure of the degree of difficulty in changing asset positions in a portfolio. Highly liquid assets are easy to buy and sell. Some examples of relatively liquid assets tend to be large cap stocks, United States treasury bonds, and relatively generic exchange-traded fund products. Illiquid assets are those where it can be challenging to enter and exit positions. Small-cap stocks, junior bond issues, non-exchange traded equity positions, and highly speculative investments tend to have liquidity issues.

Smaller investors typically manage fewer assets and as such tend not to encounter as many liquidity issues as major financial institutions attempting to manage billions of dollars in assets. For larger institutions trying to manage many positions, it can be difficult to restructure portfolios quickly because of the sheer volume of assets being held (Erel, Isil, et al. “Corporate Liquidity, Acquisitions, and Macroeconomic Conditions.” Journal of Financial and Quantitative Analysis (2018): 1-32.). Concerns about liquidity arise not just at an individual asset level (e.g. how hard it is too long or short an asset) but at the portfolio level as well (e.g. how hard it is to buy or sell classes of assets, such as domestic bonds). Understanding liquidity and the risks associated with possible liquidity issues is a major goal of sophisticated investors.

At first glance, liquidity could be viewed as an extension of trading volume and spreads. Much of the academic literature uses this as a proxy for liquidity, and it tends to be a reasonably reliable representation in many market conditions (Chang, Briana. “Adverse selection and liquidity distortion.” The Review of Economic Studies 85.1 (2018): 275-306.) (COLLIARD, JEAN-EDOUARD, and Peter Hoffmann. “Financial transaction taxes, market composition, and liquidity.” The Journal of Finance 72.6 (2017): 2685-2716.). For example, the mix of using the bid-ask spread of an asset and the dollar value of a typical daily volume can give an idea of the amount of liquidity an asset has on a usual day. However, this can be misleading. Liquidity is not a constant stream, and at times there can be liquidity freezes. Furthermore, asset liquidity can have dependencies across a portfolio. A famous example of this is the “flight to quality” crisis faced by the firm Long-Term Capital Management (Sarno, Paula Marina, and Norberto Montani Martins. Derivatives, financial fragility and systemic risk: lessons from Barings Bank, Long-Term Capital Management, Lehman Brothers and AIG. No. PKWP1812. 2018.). This famous example in the literature occurred after Russia defaulted on some bond obligations, triggering investors in the bond market to panic, sell off riskier bonds and buy the safest bonds available. Long Term Capital Management invested heavily in bonds trading at a premium with similar structures to other more liquid bonds. The portfolio was layered and structured to allow for some amount of selling off and liquidity flexibility. However, due to a Russian default, the demand for high-quality bonds soared, and investors quickly moved out of lower-quality assets into high quality, high liquidity bonds. As a result, Long Term Capital Management incurred losses on short terms in high-quality bonds and incurred losses for its long position on low-quality bonds which resulted in a negative position in assets. When each asset was analyzed, there did not appear to be a liquidity issue, and private market spreads did not suggest a significant problem in liquidity structure. However, all of the assets had a highly correlated liquidity risk that was not hedged causing the standard metrics of liquidity risk to conceal an unexposed market risk.

Highly correlated risk structures can present unique risks that are not easily discerned by traditional metrics (Fuleky, Peter, Luigi Ventura, and Qianxue Zhao. “Common correlated effects and international risk sharing.” International Finance 21.1 (2018): 55-70.). In the case of Long Term Capital Management, it was a complex liquidity risk regarding the hedge between bond quality which was not captured in traditional analytics and data summarization. New advances in data analytics make the summary, analysis, and discerning of these risks possible. However, this process is not straightforward. A machine-learning algorithm may suggest a certain kind of risk exists when company fundamentals suggest this is not a credible threat, while an econometric algorithm may find risks that appear not to be hedged but are actually covered. The difficulty of assessing these risks is non-trivial when using multiple different analytic techniques and perspectives, as it requires managing the pitfalls and shortcomings from various analytic approaches together to analyze liquidity, which itself can be misleading at times (Boudoukh, Jacob, et al. The complexity of liquidity: The extraordinary case of sovereign bonds. No. w22576. National Bureau of Economic Research, 2016.).

Monte Carlo simulation is one of the most popular analytic techniques in finance (Crum, Michael, and Charles Rayhorn. “Using Monte Carlo Simulation for Pro Forma Financial Statements.” Journal of Accounting and Finance 19.5 (2019).). The ease of use and analytic simplicity made it a favorite of portfolio managers when cloud computing was not feasible. However, it is limited in use and scope. Monte Carlo simulation cannot feasibly be deployed in complex, high-dimensional environments with multiple factors under consideration. Markov Chain Monte Carlo (MCMC) allows for analysis in these more high-dimensional spaces by using Markov chains structured over time to explore high-dimensional and non-linear topologies. With parallel computing and cloud servers, it is possible now to use more sophisticated MCMC approaches to characterize these spaces and understand correlated risk at a deeper fundamental level (Vono, Maxime, Nicolas Dobigeon, and Pierre Chainais. “Split-and-Augmented Gibbs Sampler—Application to Large-Scale Inference Problems.” IEEE Transactions on Signal Processing 67.6 (2019): 1648-1661.) The present invention also uses techniques from decision theory (Riedel, Frank, Chris Shannon, and Jan Werner. “Foreword to the special issue on “Robustness, Knightian uncertainty, and games in finance”.” Mathematics and Financial Economics 12.1 (2018): 1-3.), machine learning (Ghoddusi, Hamed, Germán G. Creamer, and Nima Rafizadeh. “Machine learning in energy economics and finance: A review.” Energy Economics 81 (2019): 709-727.), and time series econometrics in the analytical process (Siami-Namini, Sima, and Akbar Siami Namin. “Forecasting economics and financial time series: ARIMA vs. LSTM.” arXiv preprint arXiv:1803.06386 (2018).).

U.S. Pat. No. 10,715,393 (Madhavan) uses time series methods to characterize changes in assets over time and assign them to a system to make decisions. This patent has applications capable at performing task management, such as the analysis and management of liquidity. However, unlike the present invention, the search and analysis process uses time series based techniques. The present invention includes methods for computational physics such as Markov Chain Monte Carlo to make search and selection decisions. Furthermore, the analysis system in the present invention extends beyond time series analysis to include decision theory and machine learning algorithms to characterize processes over time. However, Madhavan does use a machine learning model for predictive purposes, the present invention also uses machine learning for broader classification and dynamic search, which is not included in Madhaven.

U.S. Pat. No. 10,713,723 (Burns, et al.) addresses the problem of providing specific recommendations on asset selections and purchases based on price spreads. While price spreads are one measure of liquidity and other factors are taken into consideration, the present invention considers, analyzes, and characterizes liquidity as a multi-dimensional structure based on data analytic algorithms. While this approach offers a trading strategy, it is based on instructions presented by a processor. In the present invention, the system is designed to use cloud-based parallel computing, which allows for multiple processors in parallel and various types of processors (CPU and GPU) in the computation. Furthermore, these suggestions are based on rebalancing to an optimal portfolio for a suitable long-term investment rather than a rapid execution of liquidity mismatches. As such, the analytical technique, computational approach, and method for management of liquidity in the present invention differ from Burns, et al.

U.S. Pat. No. 10,147,138 (Friesen, et al.) focuses on the presentation of a user interface system for comparing inherently interchangeable assets. In this system, interchangeability is determined based on the legal relationship between assets. For example, one share of one asset is valued at an equivalent number of shares of another unit and looking for liquidity relations between these assets. In the present invention, the liquidity analysis is based on underlying asset structures and the fundamentals between companies. The current innovation differs from Friesen, et al. in that it considers whether there are shared risks between the companies rather than determine whether one share of Company A is legally equivalent to a certain number of shares of Company B. Aspects such as whether Company A is a supplier or vendor to Company B are taken into substantial consideration. While the graphical system in Friesen, et al. displays relations between companies, the current innovation displays complex statistical relationships over time expressed using data analytic methods. Friesen, et al. fails to disclose data analytic techniques such as machine learning and time series econometrics and Markov Chain Monte Carlo based search methods. This failure prevents the system from addressing deeper statistical and structural issues in asset liquidity.

U.S. Pat. No. 10,706,473 (Vaidyanathan, et al.) focuses on a process for customizing a portfolio based on a variety of factor exposures, such as liquidity. In Vaidyanathan, et al., portfolios are customized based on risk premium scores. The five factors considered are value, quality, momentum, volatility, and liquidity and are provided, collected, and harvested at scale. However, this approach differs in scope, approach, and analytic structure from the current invention. Vaidyanathan, et al. uses portfolio construction techniques and analysis that are “well tested,” while the present invention uses new and innovative techniques to analyze portfolios. Vaidyanathan, et al. does not explicitly mention the use of Markov Chain Monte Carlo, machine learning, or time series analysis. Instead, Vaidyanathan, et al. relies on standard econometric procedures to analyze and characterize these five factors over time. The current invention computes the nature of risk in a different manner. Rather than being “inexpensive to harvest at institutional scale,” the current invention considers many more factors in a high dimensional computation that views these risks as unique and custom to each investor. High dimensional search and analysis implements state of the art analytics techniques in combination leading to complex and nuanced structures that rely on advances in scientific and cloud computing. The portfolio search and customization process over liquidity and other factors focuses on the individual user and the uniqueness of the client, rather than traditional portfolios. As such, the resulting process, presentation, process flow, and underlying world view of the present invention represent an entirely different business process procedure.

U.S. Pat. No. 10,706,471 (Lutnick, et al.) addresses liquidity through the use of market-making mechanisms. In Lutnick, et al., trades between the buy and sell-side participants are matched and analyzed to propose new market-clearing prices. Lutnick, et al. addresses liquidity through the market-making process of matching buyers and sellers by adjusting prices and spreads. The computer process of the present invention instead operates to understand how liquidity is structured and will evolve rather than acting purely as a market-making agent. The present invention instead focuses on individual clients and providing clients with suggestions specific to them to manage liquidity over time, rather than solving an equilibrium condition to serve as a market-making agent.

U.S. patent application Ser. No. 16/548,505 (Kotarinos and Tsokos) addresses overall portfolio structure and asset allocation. While this previous filing focused on constructing a portfolio in its entirety over multiple criteria, the application focuses primarily on understanding and dissecting liquidity across multiple dimensions. As such, it differs in scope to the previous filing and while is a similar work is not a continuation of the previous patent application.

U.S. patent application Ser. No. 16/841,024 (Kotarinos) addresses methods to rebalance a portfolio and notify a user about the current state of his or her assets. This primarily focuses on suitability of assets. The proposed innovation focuses on liquidity and the rebalancing and adjusting of a portfolio based on liquidity concerns. These concerns and rebalancing recommendations are generated by a different procedure from application Ser. No. 16/841,024 and are different in scope.

U.S. patent application Ser. No. 16/824,998 (Kotarinos and Tsokos) focuses on a method known as a democratized voter system with applications to trusts and endowment funds. This system has useful applications when making a decision on behalf of one or more users. The proposed innovation focuses on liquidity for one user. However, it can be used with multiple users by using some of the technological innovations included in patent application Ser. No. 16/824,998. As such, the disclosure of patent application Ser. No. 16/824,998 can lead to some unique applications and features when used in concert in a system.

U.S. patent application Ser. No. 16/790,291 (Kotarinos and Tsokos) focuses on a digital system for making assignments across money managers. In the proposed innovation, this system focuses on liquidity of assets. The application of the present invention can be used in combination with the applications disclosed in application Ser. No. 16/790,291 to make an allocation to different money managers that takes into consideration the liquidity of investments made. This is a particularly innovative combination as money manager allocations are typically not analyzed in regard to the liquidity constraints that occur from using certain combinations of money managers in joint combinations. U.S. patent application Ser. No. 16/790,291 is incorporated by reference in its entirety to the same extent as if the disclosure is made as part of this application.

U.S. patent application Ser. No. 16/829,139 (Kotarinos) uses multiple different decision-making perspectives to make asset allocations. In this system, rather than using multiple decision theory frameworks the proposed innovation uses multiple different kinds of analytical processes in an ensemble. This proposed innovation also has a different architectural structure, as patent application Ser. No. 16/829,139 focuses on mixing different methods together. In particular, in patent Ser. No. 16/829,139 the stacked layer is of dimension at most two, with one high-level method and lower-level methods at a single stack layer. The result is that processes in the lower level must be mixed together and blended, rather than being allowed to operate jointly. This eliminates the analysis of interactive effects within the layer. These patents can be used in combination to allow for scalable and computationally efficient deployment of multiple analytical systems and multiple decision making processes in a single deployable environment. U.S. patent application Ser. No. 16/829,139 is incorporated by reference in its entirety to the same extent as if the disclosure is made as part of this application.

### SUMMARY OF THE INVENTION

The present innovation is an advancement of the theories regarding portfolio management and liquidity to consider the entire structural nature of liquidity as it exists across a collection of assets at different points in time to construct a portfolio for a client. Rather than focusing on the liquidity risk of individual assets viewed one at a time and then looking at the collective risk of the portfolio, the innovative technology developed characterizes the liquidity risks of the assets considered collectively in terms of the asset and market structures. Rather than having a one-dimensional view of liquidity in terms of asset liquidity at a point-in-time, the computer predictive system of the present invention allows for the use of big data analytics to dynamically model and characterize how liquidity will evolve in hypothetical scenarios, allowing for the real-time modeling and characterization of liquidity risks and opportunities as they develop. The computer system of the present invention analyzes asset liquidity relationships and structures over time. By doing so, the present invention marks an advance in the characterization and study of liquidity and addresses a client's propensity for liquidity and risk. The present innovation uses the following 10-step computer predictive application system to make portfolio liquidity recommendations:

1. Using software to derive a set of preferences to construct a portfolio of assets, including some preferences over liquidity by assigning a preference score to the preference.

2. Using the preference score to construct the relevant universe of assets that are potential candidates for a portfolio.

3. Analyzing the universe of assets and considering the preferences other than liquidity to construct an initial portfolio.

4. Characterizing the relationship between the different assets that were chosen to be included in the portfolio and other candidate assets in terms of preferences other than liquidity to derive a set of candidate assets.

5. Analyzing relational liquidity dependencies between candidate assets and derive assets that have patterns in their behavior via the use of trading data and fundamental data. Further characterize these dependencies to create possible relational mixes for components of the portfolio.

6. Structuring various kinds of relational mixes to create a mapping and search process for possible portfolios.

7. Characterizing and classifying the initial portfolio's liquidity over time via the use of regressions, machine learning, and big data analytics and further decompose these liquidity structures over relational structures.

8. Presenting the client with the liquidity risk and other risks of candidate portfolios derived from high suitability regions. For each of these portfolios, repeat the techniques from step 7 and present them to the client. Allow the client to investigate each portfolio in further detail.

9. For a given investigated portfolio, presenting the client with a structural overview of the investigated portfolio and his or her current portfolio. Show which liquidity risks exist in the investigated portfolio and how the client would adjust and manage liquidity related asset decisions in different scenarios to better illustrate the exact nature of these risks. Continue this process until the client picks a target portfolio.

10. Once the client settles on a target, the portfolio suggests rebalancing steps. These steps will include the order to make the asset change and the necessary severity of the suggested change from the current allocation to the suggested allocation in the target portfolio.

### BRIEF DESCRIPTION OF THE DRAWINGS

The detailed embodiments have other features which will be more readily apparent from the detailed descriptions, the appended claims, and the accompanying figures. A brief introduction of the figures is set forth below.

FIG. 1 is a flow chart depiction of the overall system for conducting a liquidity analysis of the present invention;

FIG. 2 is a depiction of the manner of deriving the liquidity preferences of a client in one embodiment of the present invention;

FIG. 3 depicts the process for constructing an initial portfolio using analysis patterns across time between assets and analyzing patterns across data to make a decision using decision theory;

FIG. 4 is a detailed depiction of the asset fundamental linkages based on the analyzed patterns across time between assets in one embodiment of the present invention;

FIG. 5 is a detailed depiction of the asset chains being applied through data analytics in one embodiment of the present invention;

FIG. 6 depicts an example of the composition of the liquid analysis of chains of the initial portfolio as compared to additional scenarios;

FIG. 7 shows the MCMC search process utilized by the present invention; and

FIG. 8 shows an example of portfolio rebalancing in the present invention.

### DETAILED DESCRIPTION OF THE PREFERRED EMBODIMENTS

The present invention is computer application tool to construct a system for analyzing liquidity preferences, building a portfolio of assets based on the liquidity preferences and constructing a platform of recommended steps to rebalance a portfolio. The user may select a preference for certain types of assets which is used to generate a client preference score. The client preference score is utilized to construct a universal of selected assets that are prepared based on the user preference score. The present invention operates to generating a computer-implemented initial portfolio from the universe of assets. The system operates to pass the initial portfolio through an analysis process algorithm that utilizes decision theory, machine learning and time-series econometrics to generate a characterization value based on the relationship between assets in the universe of potential assets in the initial portfolio. Creating a liquidity structure among the assets in the initial portfolio across time and running a Markov Chain Monte Carlo based structure search process across the assets in the assets in the initial portfolio. The results of the Marko Chain Monte Carlo search on the initial portfolio is presented in a computer-based portfolio data set formulate from the initial portfolio. A data analytics process is applied to the portfolio set to generate a characterized result data set. The characterized results data set can be presented to the client via a user interface system. The user has the ability customize his or her portfolio based on the characterized result data set. Once the user settles on a portfolio, a series of rebalancing process steps may be provided to rebalance the user's assets and holdings.

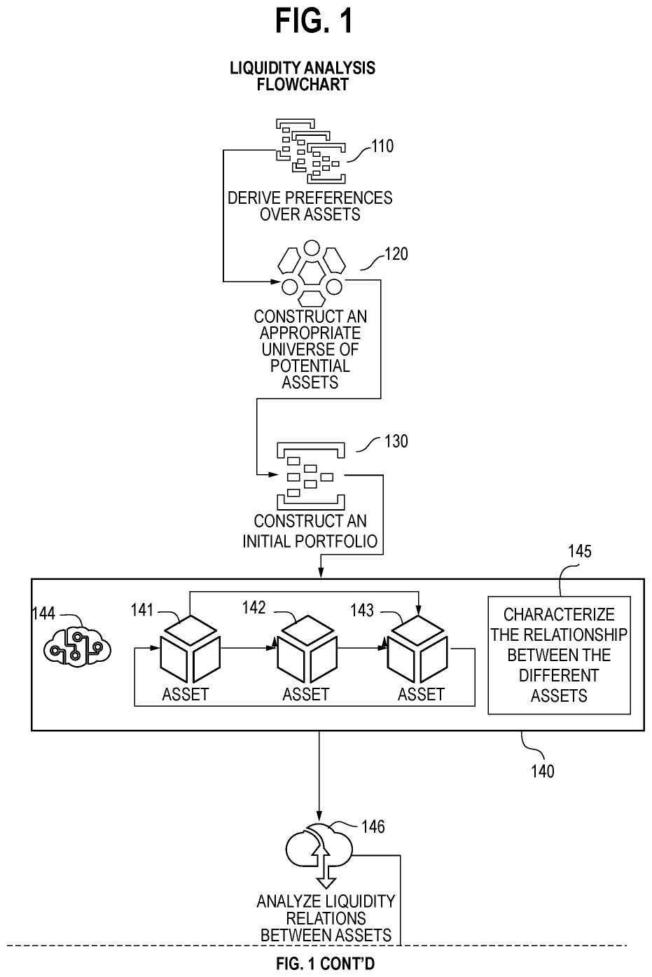

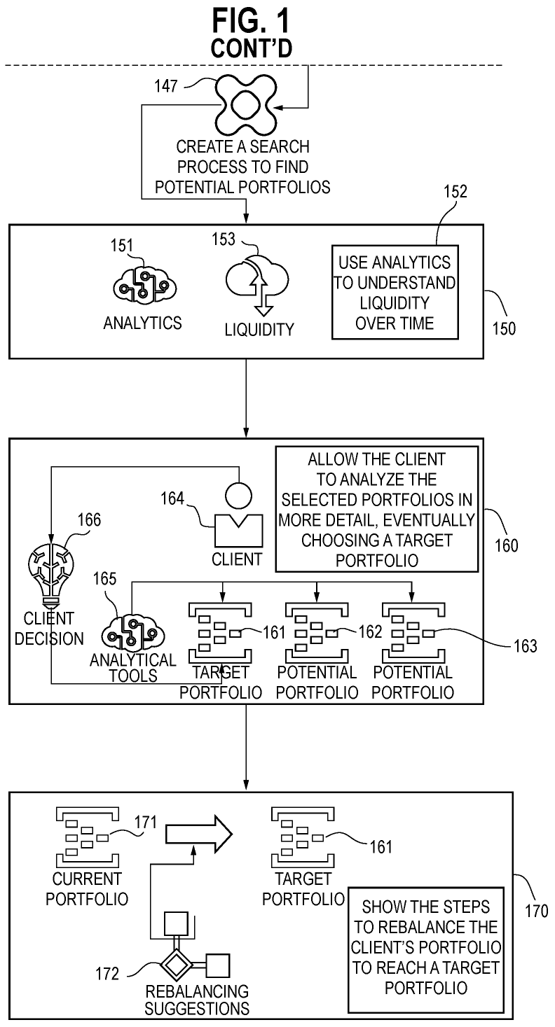

The present invention operates in a series of steps which are described in detail below with reference to FIGS. 1 through 8.

The first step 110, shown in FIG. 1, in the process involves constructing a clear set of preferences over assets. To derive this set of preferences, a client 201 may provide responses on various questions 202 to extract relevant and material information about goals 210 to formulate a preference score. The goals are translating into a client preference score 224 or 225. For example, a portfolio built to generate income in retirement 210 will be structurally different from a portfolio constructed to maximize short-term return 210, which will also be different from a portfolio aiming for long-term growth 210. This process involves an evaluation of goals, objectives, and financial suitability of a client 220. Goals are the desires of a client, such as owning a house and being able to retire by a certain age. To reach these goals, a portfolio needs to achieve certain financial objectives. For example, a young professional may have a goal of one day retiring 210 and, as such, have the aim of reaching a certain level of assets by a certain age. Another example would be the goal of being able to save and purchase a house 210 and, as such, having the objective of reaching a certain level of savings while taking on a low level of risk to the underlying investment. Considering the goals and objectives 210 leads to determinations about suitability of a preference for assets based on a liquidity preference score. Suitability classifies individual investments in terms of how appropriate they are for an investor based on a liquidity score. The young professional may find that growth stocks are the most suitable for his or her goal of retiring as he or she does not need immediate income. For the young professional, if he or she is not a sophisticated investor, then a hedge fund may not be appropriate even if it does have strong growth prospects, as the investor does not correctly understand the risks of the investment. Because of this, suitability has multiple dimensions and subtleties. Judged merely on growth alone, a hedge fund may seem like an ideal investment. Still, it may not be appropriate since the investor, due to the complicated risk structure of hedge funds, may not be able to properly understand what level of risk he or she is taking at a given time. The addition of hedge funds may severely cripple the structuring of an appropriate and understandable portfolio for this specific individual. Through an evaluation of a client 201, the system can learn more about a client's preferences and what investments are appropriate. Knowing suitability and appropriate investments for a client is a significant component of the regulatory requirement of “know your client” that requires financial planners and some portfolio managers to understand the client's needs to fulfill their fiduciary duty properly. Once the appropriate suitability conditions are established, this allows for a determination of the kinds of investments to consider and the assets that would be appropriate for his or her client.

A client preference score may be generated based on the preferences of a client in the evaluation of objective suitable 220. Based on the client preference score; a potential universe of portfolios 230 for consideration is developed. This restriction involves filtering investment vehicles for those that meet the requirements to be possible candidates, excluding those assets that are not a good fit. Based upon the liquidity preference score and derived preferences, the application constructs an appropriate universe of potential assets 120 while a portfolio with these included may appear as a whole to be more appropriate, it is reasonable to conclude an unsophisticated client would not understand these instruments well enough to properly understand the risks associated with owning these contracts. Asset classes that are commonly excluded include municipal bonds, derivatives, foreign and emerging market company stocks and bonds, small-cap stocks, hedge funds, high fee mutual funds, cryptocurrencies, alternative investments (such as paintings), and highly leveraged financial products. The asset classes may be provided a utility matching metric to compare to a liquidity preference score. Each investor is unique, and as such, an asset class may be appropriate for one investor but not for another. For example, a more sophisticated investor may be able to tolerate a small number of derivative positions but will not want cryptocurrency positions. Another client may, even after being suggested the contrary, desire to hold cryptocurrency and will need adjustments made to the rest of the portfolio to accommodate this. A careful analysis of the client's objectives and financial sophistication is necessary to restrict portfolio creation to only include desired assets.

The third step 130 in the process involves analyzing the chosen universe 120 of assets 310 based on the client preference score and a utility matching metrics assigned to the asset classes and constructing an initial portfolio of assets 130, leaving aside liquidity for the moment. In this step, the assets 310 in the initial portfolio 130 are selected from the universe of potential assets based on the preferences of the client. For example, a client who wants growth 224 will likely have some investments in technology-based companies, while a client who wants income generation 225 may invest in real estate. The difficulty inherent in the process is choosing an appropriate mix of assets such that the portfolio maintains some properties of global optimality. The assets may be assigned a metric which may correspond to the client preference score. The proper utility matching metrics are utilized to measure the asset metrics against the client preference score to select a combination of assets that conform with the client preference score. For example, many assets 310 may appear to be appropriate individually, but taken together may create new risks. As an example, a rapidly growing company may seem appropriate for a growth investor but may be a supplier to another growth company that is already in the portfolio. If the client company performs poorly, so will this supplier. Having both companies in the portfolio creates a highly correlated risk. Methods from modern portfolio theory have focused on addressing the overall correlation structure of the portfolio and the risk profile of the portfolio as a whole. Many of these methods were developed before the widescale commercial feasibility of cloud computing, Graphical Processing Unit (GPU) based computation and advanced computational search and optimization methods. As such, much of the optimization focuses on a single snapshot point in time rather than more complex structural qualities. The initial portfolio of assets 310 may be passed through two separate data analytics: the process of the time series analysis 320 and a machine learning analysis 330. The data analytics is conducted through an algorithm that performs the required steps to either review the patterns across time and assets and patterns across different data analysis 332 such as the correlation when oil is high 331, the sensitivity to euro exchange rates 332 or the sensitivity to interest rates 333. The time-series algorithm 320 analyze patters across time between assets.

Time series analysis relates to a field of analysis that focuses on panel data. Panel data refers to data that has a relationship over a time dimension. For example, the daily trading prices of a stock have a relationship over time such that the previous day's closing price is more indicative of the trajectory of a stock than the closing price a week ago, and the closing price a week ago is more indicative of a stock's trajectory than the closing price a month ago. In this example, the algorithm analyzes trends and patterns to see if certain assets are related. There are several methods that are used to do this. As an example, cointegration can be used to see if there is a relationship between two assets by seeing if the difference between these two assets forms a kind of process known as a stationary process, or one whose mean and variance is constant over time. This can be a direct relationship between assets or delayed by looking at lagged relationships. Another possibility is to use Long Short-Term Memory (LSTM) methods and other machine learning techniques. Cointegration and LSTM can be combined with other techniques such as correlation analysis via a correlation matrix, autocorrelation analysis, autoregressive integrated moving average models, and other techniques to investigate possible trends and then statistically test for them. While this is a summary of some of the ways to test for statistical trends over time, it is in no ways exhaustive of all the techniques that can and are used and some of these techniques and the specific mix of techniques used are proprietary. This discussion is meant to be indicative of what techniques could be used in combination, but the exact ways in which they can be combined and the mixing techniques vary based on use case, computational resources, and a variety of other factors and as such it is difficult to make exact recommendations without knowledge of the desired application.

The assets 310 relationships over time 321 may be compared and analyzed in the algorithm 320. The preferred innovation uses time series analysis, machine learning 330, decision theory, and financial econometrics to more closely characterize the portfolio 311 based upon the utility matching metrics for the liquidity reference value. This is done by using time-series methods to analyze signal patterns across the portfolio 130, using machine learning to identify trends across large data environments, decision theory to analyze the artificial intelligence driven decision making process and financial econometrics to understand the financial implications of the decision. The portfolio characterization may be supported by a cloud-based environment for fast and scalable computation, which allows for the deployment of additional computational resources, servers, and architecture on- an as-needed basis.

The end result of this process is a portfolio that is constructed in real-time to meet the investor's goals other than liquidity. It may appear strange that the proposed liquidity innovation ignores liquidity for the time being, but this is because the portfolio creation process runs a search and optimization process over liquidity in a later step. This initial portfolio serves as the initial starting point of further search and optimization. With a long enough search process, the relationship between the initial constructed portfolio and the final portfolio continues to decrease. This results from the search algorithm which allows for the system to display asymptotic independence from the starting position of the search. The result is asymptotic in nature. It is important that the initially constructed portfolio is in the appropriate neighborhood so that the search and optimization process will “find” the right portfolio and search in the appropriate topological region. The portfolio created should be structured correctly, but the individual asset selections themselves are not as important as the overall structure they create when viewed collectively. Because of this, the innovative practice of characterizing liquidity later in the construction process is adapted because of the process for analyzing the topology that is adapted in this proposed innovation.

The fourth step in the process involves characterizing and understanding the relationship between assets in terms of fundamentals. A time-series analysis technique is utilized on the portfolio to determine a relationship of assets based on the relationship of the asset structure and composition. The assets are provided a fundamentals score during the time-series analysis technique to determine any relationship between the assets. Any relationship between assets is determined by the fundamentals score and categorized accordingly. The set of assets is provided a nuanced fundamental link based on the fundamentals scoring.

The fourth step 140 involves understanding how the assets selected in the internal portfolio are related to each other in terms of asset structures and fundamentals composition. In the fourth step, the assets in the initial portfolio are run through a time-series analysis approach 144 to understand how they are related in terms of their fundamentals and relations over time. Consider the previous example of two companies, one of which is a supplier to the other. If the company using the other as a vendor anticipates a decline in business activity, then the supplier is likely to also experience a decline in business activity. The result is that both common stocks are likely to trade down. However, this may not occur at the same time. Because markets take time to process information, this may not occur for some days, so there could be a lagged factor. Over time with enough data even with noise, one can determine these lagged relationships with time-series analytic techniques such as cointegration and spectral decomposition. These relationships can also extend beyond price and can be seen in areas such as leverage and earnings multipliers. For example, during certain periods of time, certain sectors tend to move similarly beyond price. For example, during periods of diminished air travel, airlines will tend to trade at lower earnings multipliers and take on more debt. The economy tends to move through phases and cycles, with some cycles being sector specific. These cycles can induce an inflow of investment and capital expenditure at once in a certain sector, leading to a boom in sales in another related sector. Likewise, a decrease in investment in one sector can have implications in other sectors. For example, a decrease in investment in airline companies can create leverage in a defense contractor that makes commercial airplanes, but not in a defense contractor that only makes military equipment. These relationships can be complex. A mix of various time series techniques may be combined with other areas such as decision theory and machine learning to characterize and build complex time-dependent linkage models.

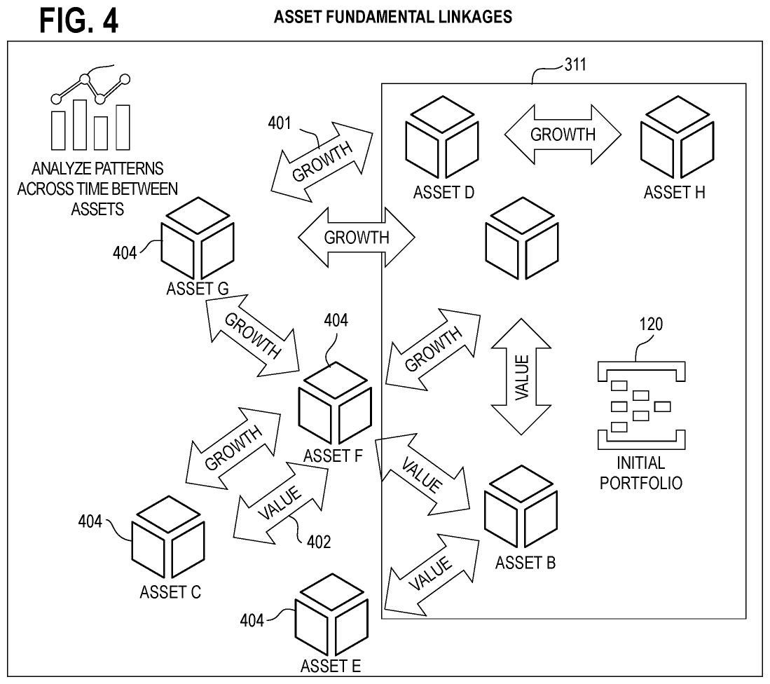

The end result of the complex linking process is a set of assets that form an initial portfolio, A through G (404) in FIG. 4, with nuanced fundamentals links 401. The assets in the initial portfolio 130 are linked to assets outside of the initial portfolio 404 in the broader space. These linkages can sometimes be between more than one asset, rather a block of assets that together are related. For example, two companies partnering together on a joint initiative may move together and have a relational structure when viewed jointly with a supplier. These relationships can be multiple chains deep. For example, Company A in the initial portfolio and Company B outside of the initial portfolio could have a relationship to Company C. Company C may have a relationship to Company D, which is outside of the portfolio, which has a relationship with Company E, which is outside of the portfolio. One of the aspects that makes this process unique is that the search process and characterization does not assume transitivity. The transitivity assumption assumes that if X is related to Y and Y is related to Z, then X is related to Z. However, in this case, this may not be true due to the complex multi-dimensional nature of the data. For example, company X may trade at a similar earnings multiplier to company Y, and company Y may maintain similar leverage to company Z, but company X and Z, when viewed in a vacuum, may be unrelated. This is because these relational structures can exist as it relates to certain criteria. Each of these characterizations is further decomposable at the individual investor level. For example, if an investor is not concerned about the degree of leverage, then the leverage relationship between companies Y and Z may not be a material concern. The present innovation considers the unique characteristics of each investor based on the liquidity preference score and the material concerns that are unique to each investor when constructing portfolio links. These portfolio links create a set of alternatives that can be used. For example, if an investor is primarily concerned about earnings multipliers at a certain point in time, then companies X and Y may represent similar exposures. The portfolio manager can switch between these assets by moving the portfolio components with these linked chains. As such, these linked chains allow a portfolio manager to restructure the portfolio in real-time.

The fifth step 150 in the system of the current invention involves understanding liquidity relationships between assets. In the fourth step, a process is deployed to characterize linkages between assets based on fundamentals. In the fifth step 150, these fundamentals linkages 510, 512 are deconstructed to notice liquidity links and patterns using time series econometrics. The process of dynamically searching over the fundamentals links and examines liquidity events over time. A computer algorithm utilizes a time-series regression technique to determine a liquidity relationship based upon a liquidity score 520, 530 and 540. For example, an energy company stock may be very liquid but may run into liquidity issues when oil trades in certain regions. In this step, time-series regressions are run on assets and blocks of assets to determine what factors impact liquidity at different time periods. These regressions are combined with game theory models that describe the preferences and behaviors of patterns of investors to see if certain conditions could arise that could cause a liquidity crisis, and then machine learning is combined with the time-series approach to ascertain the likelihood of these events occurring. These time series regression models are developed by using a relational topology structure rather than traditional techniques. That is to say, each regression's parameter selection search process is determined iteratively by other assets with similar topologies. For example, suppose there are two restaurant groups that operate in the United States with similar market caps. The regression model selected for the first restaurant group would provide insights on how to structure the model for the second group. By utilizing these trends and running machine learning on these structures, complex regression structural decisions can be automated and performed in real-time. By building these relations and structures, one can understand the liquidity risks each part of the portfolio represents.

By scoring the liquidity risk of each part of the portfolio 130, it is possible to build unique and innovative asset mappings and asset mixes. For example, suppose assets A, B, and C are in a portfolio. Asset A is illiquid, asset B is relatively liquid, and asset C is very liquid. Suppose further that assets A and C have similar exposures. For example, assets A and C could both be real estate companies except with more liquidity in C. In a vacuum, asset A is a more desirable investment except for the fact it is less liquid. In structuring a portfolio, the manager could balance the illiquid nature of A with some holdings in C. In case the portfolio manager wanted to move assets out of the real estate space, he could quickly sell his positions in asset C. Meanwhile, the portfolio manager could slowly sell off positions in A. Since A is less liquid, it will take longer to liquidate. However, the portfolio manager can still make rapid changes to the overall portfolio structure by having some of the real estate portfolio components in C even though it is less of an ideal fit in other preferences. As such, the portfolio manager can trade-off between other preferences and the relative weights of assets A and C, while leaving asset B fixed.

While this simple example of moving assets between A and C is straightforward, the underlying structure can be more complex. Recall that the asset chains constructed in step 4 may not be straightforward linear relationships and trading off between assets A and C could affect other assets and other preferences. For example, another asset, say asset D, may not be an appropriate asset to hold with a large amount of asset C as they may be highly correlated. As such, the trading off between asset mixes needs to consider a variety of factors and conditions at once because the underlying optimization topology is highly dimensional and complex. For example, one could hedge possible exposures with derivative contracts such as calls and puts. However, these contracts themselves can often be illiquid and there could be a liquidity crisis on the contract used to address another liquidity crisis. The illiquidity of the derivative contract could be addressed by pairing it with other contracts at different strike prices. This process can continue, with multiple types of liquidity issues that can arise at different times.

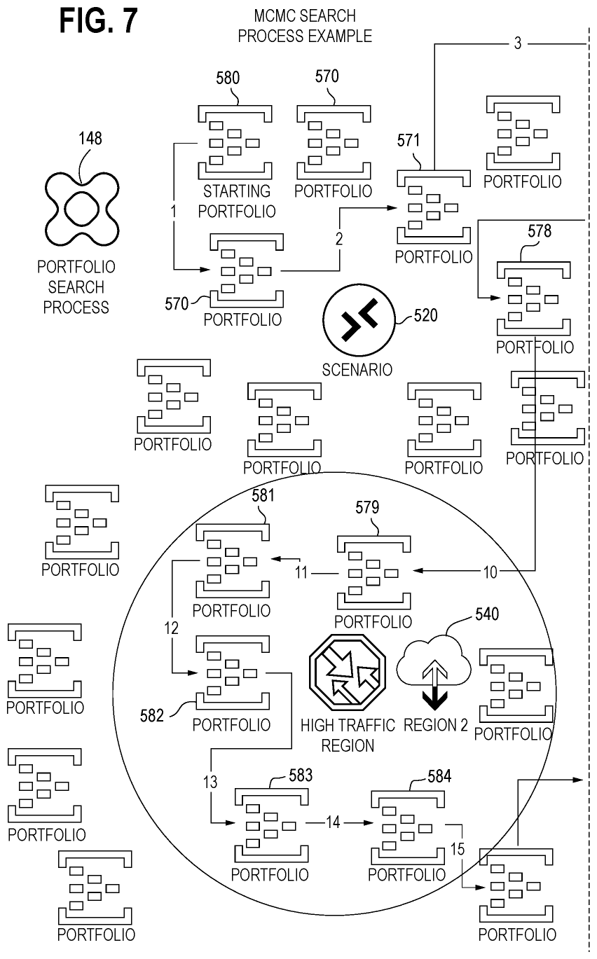

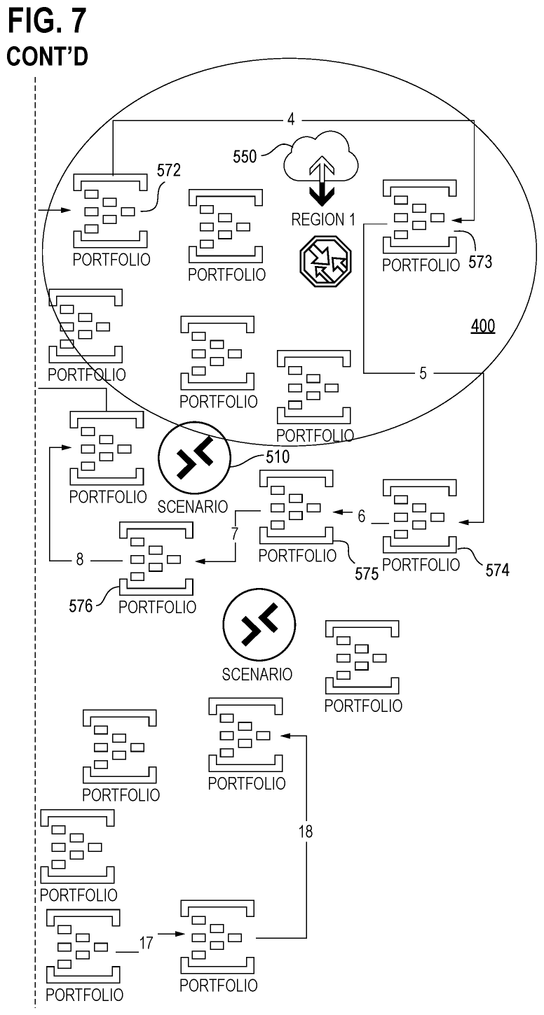

In order to address the complexity of measuring the fundamentals relationship and liquidity relationships, a real-time cloud computing-based machine learning approach combined with a fast optimizer and search process is needed. In the present innovation, machine learning is run to notice structural patterns across the topology. This is combined with a Markov Chain Monte Carlo (MCMC), as shown in FIG. 7, the approach to iteratively run over and search for optimal allocations and solutions for different kinds of liquidity preferences. The MCMC approach 700 allows for the analysis of the complex, varied, and non-linear asset space using advanced methods from scientific computing. The MCMC 700 techniques allow for GPU acceleration and parallel computation, and sophisticated techniques from MCMC theory allow for efficient portfolio searches.

The MCMC process 700 can be run iteratively to search for different portfolio mixes such as the starting portfolio 701 and other portfolios 702 and 703. In order to create a process that runs quickly and in real-time, the search can be tailored to run in regions that are highly likely to return satisfactory portfolios. This is done by using machine learning to categorize the topological space and mark regions in terms of their likelihood of containing suitable portfolios in terms of liquidity risk. The machine learning algorithm 710 classifies topological regions based on the kinds of liquidity risk the region is mathematically expected to contain. By using game theory, one can make characterizations about the kinds of risks that are expected to occur in different topological subspaces. By running a game theory algorithm over these expected characterizations and comparing it to actually observed risks, the machine learning algorithm can be run iteratively with game theory algorithms to optimize the search space and identify pockets that are likely to lead to successful liquidity hedges. Once these pockets are identified, the MCMC algorithm can search the pockets that are most appropriate for a given investor. For example, an investor most concerned about event-based liquidity risk would be interested in different topologies than an investor interested in short-term liquidity risk. This marks a significant advancement from modern portfolio theory, which tends not to deal with complex topologies and instead focuses on two-dimensional portfolio representations. The shift to a topological representation is an advancement that is only feasible in part to the advancement in computational power available on an as-needed basis. This search process is run until various proprietary metrics suggest a sufficient search has been concluded to determine potential portfolios to explore in more detail.

In the sixth step, each portfolio's structure may be analyzed with regression models based on topological fits. Topological models are generalizations of metric space models and can operate with looser assumptions. Because of this, they can be viewed of as extensions of the traditional approaches that are used to analyze data and trends. The use of topological models allows for more freedom in model construction and are often a better model of human behavior. Because many systems such as stock markets have human elements and humans are irrational, at times this leads to inconsistent results. For example, one asset may trade for less than another asset despite being a superior investment. In other areas such as political polling, one common issue is non-transitive preferences. In an election with three candidates, herein called candidates A, B, and C, a respondent may prefer candidate A to candidate B, candidate B to candidate C, and candidate C to candidate A. In a non-topological system, no analysis could be done, but in a topological space one could still make broad inferences about broader trends. Metric spaces in general are a kind of topological space, but topological spaces need not be metric spaces. This added flexibility comes at the cost of requiring more sophisticated approaches to make decisions. While in many cases the resulting regression analysis and fits will be on metric spaces it will on occasion not fall in such a space.

In the seventh step, the initial portfolio's liquidity risk is deconstructed in more detail. In this step, the initial portfolio is analyzed with an in-depth time series econometrics over many different events and scenarios. For example, in step 6, one may see the initial portfolio is sensitive to oil prices. In step 7, this can be narrowed down to certain oil price ranges and cross-referenced with fundamentals data. This narrowing is done by using fundamentals data to analyze in detail where possible liquidity traps may occur and using data to see if these results have empirical support. Machine learning is run across the data available on each part of the portfolio and used in a big data analytics environment to further refine possible trends in events. While step 6 broadly defines each part of the topology's structure, this step focuses on the specific exposures and nature of liquidity specific to the portfolio. By drilling down deeper and in more detail, portfolio managers can know not only the exposures and liquidity risks similar portfolios would have, but the exact risks the specific initial portfolio has. This depth of information allows the portfolio manager to have context on the broad risks similar investments would have while understanding in fine granular detail the particular investments chosen. The result is a detailed analysis of liquidity risks over time and across multiple different events. The produced results provide some degree of interactivity. The client is able express possible risks for scenarios of their choosing, allowing them to continue to dig deeper into the possible risks the portfolio represents. As such, this approach allows for a degree of interactivity in the risk exploration process in an easy to use and intuitive manner.

In the eighth step, alternative portfolios are selected from the high likelihood regions in the search process and presented to the client as alternatives. Each region is provided with a region scoring system based on the fundamentals scoring system and the liquidity scoring system. The alternative portfolio can be determined by the regions scoring system. For example, the client could be presented with the initial portfolio, a “high short-term liquidity risk with higher returns and lower long-term liquidity risk” portfolio and a “low short-term liquidity risk but long-term structural risk and moderately high returns” portfolio. In this step, the portfolios selected represent different kinds of allocations that represent the different goals a client wants to achieve. The earlier steps in many ways accounted for these goals, but these fine-tunes the process and reinforces the earlier results. While all of these portfolios in some way address the overall goals, this allows the client to see in detail how the different kinds of liquidity risk affect the overall portfolio structure and allow for the selection across different alternatives, each of which has their own strengths and weaknesses. Similar to the initial portfolio, an overview of the risks associated with each of these portfolios will be presented in a quick cursory manner for side-by-side comparison. This is meant to take the complexities of selecting across multiple criteria and represent it in an intuitive and easy-to-understand manner by explaining the relative differences between each portfolio. Bullet points can be used to summarize the aspects of the portfolio, and each portfolio can be selected for a deeper inspection. The system of the present invention provides an initial portfolio of assets configured for a selected liquidity preference score using marking metrics for a series of asset classes. The initial portfolio of assets is scored and measured for the fundamentals and liquidity, the initial portfolio is deconstructed and the risk factor is determined for the portfolio. Based on the risk factor alternative, portfolios are constructed using the same techniques.

The initial portfolio and alternative portfolios are provided to a portfolio manager.

This more in-depth inspection of a portfolio comprises the ninth step in the selection process. In this step, the portfolio manager can compare the client's current portfolio (his or her current allocation of assets) to each potential portfolio created in step eight to better understand how his or her portfolio compares to the new target portfolio. In this step, the client first picks one of the potential portfolios, which is run in real-time through a big data analytics process involving machine learning and time series analysis. The portfolio is then presented and compared to the client's current assets in terms of the liquidity risks. Since liquidity risk can be difficult to explain and visualize, bullet point descriptors are shown on the portfolio. The client can also see how liquidity issues would arise with an event-based explorer. In the event explorer, the portfolio's liquidity is shown across different scenarios that the client can interactively adjust. For example, the client can adjust the price of oil to see how liquid his or her portfolio would be at certain points in time. Descriptors would further describe the liquidity at these time points with phrases such as “difficult to diversify out of technology companies” and “easy to change position in high-rated municipal bonds.” The portfolio manager can swap out the selected portfolio for another portfolio, and then compare yet again to the client's current assets or against potential portfolios. By using this sophisticated real-time analytics-driven system, portfolio managers can convey complex liquidity issues to their clients and understand the different kinds of liquidity risks that can occur at different periods in time. This process continues until the client chooses a portfolio from various options.

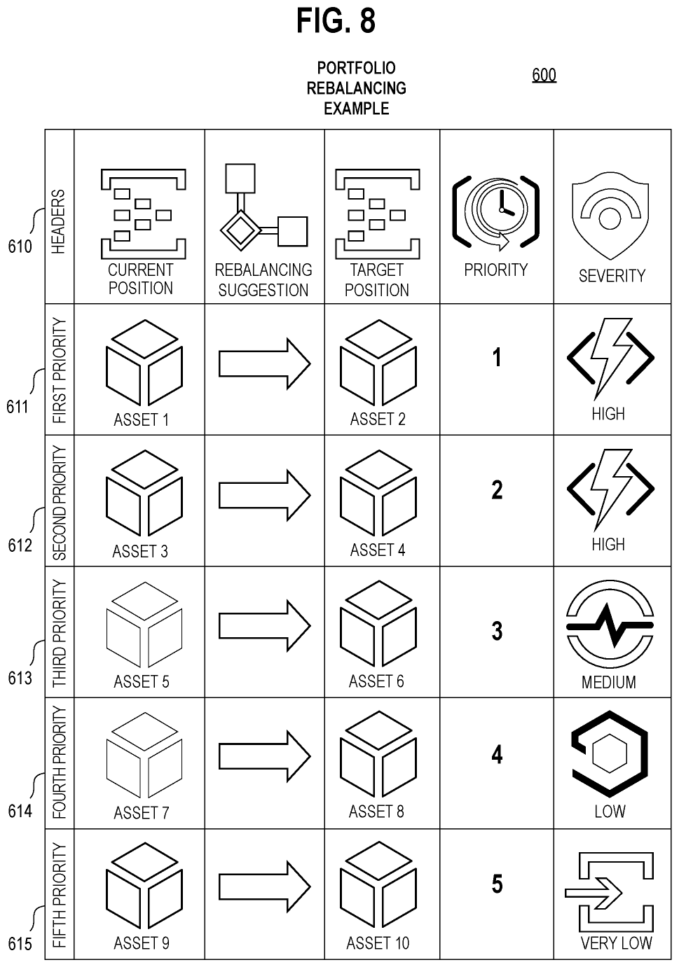

Once a portfolio is chosen, the final step involves rebalancing the client's current portfolio as shown in FIG. 8 to the portfolio he or she chose in step 9. During this process, the portfolio is run through a rebalancing algorithm that uses optimization theory and measure theory to decide what the biggest allocation issues are in the client's current asset allocation. The current allocations are compared using techniques from optimization and measure theory to determine how to rebalance the portfolio. The client is then presented with a series of rebalancing steps in order of severity, showing what asset or collection of assets to short from his or her current portfolio (sell) and what asset or collection of assets to long (buy) to get closer to the chosen allocation. In addition to being presented in order of severity, the steps are also classified based on how urgently these actions should be taken. For example, some transactions will be labeled as being needed “urgently,” while other transactions can be taken “when feasible.” The result is that the portfolio manager will then be able to, over time, reposition the client's portfolio as market conditions make for favorable restructuring conditions. This technique allows the portfolio manager to systematically move assets for the client's benefit while understanding the implications of each of these rebalancing decisions.

The above system will be described below with preference to certain figures to further explain the present invention.

FIG. 1 depicts a flowchart of the innovative business process 100. In the first step 110, the client provides his or her preferences based upon a series of questions. The system quantifies and describes the preferences in such a way that they are usable with the corresponding liquidity analyzer tool. The preferences may utilize a client preference score to correlate with the liquidity analyzer tool which may consider the utility metric of an asset. A client preference score is determined and applied for the client. For example, a client that is worried about a portfolio losing value and being unable to move assets out of a position would want a more liquid portfolio. In the next step 120, the search is restricted to a suitable universe of assets based upon the liquidity preference score. The search 120 employs a measuring metric for the assets to be compared with the client preference score of the client to construct an initial portfolio based on the comparison of the client preference score and the measure metric of the assets 130.

In the fourth step 140, a time-series analytics technique 144 is utilized to identify the relationship in terms of the fundamentals based on a fundamentals score. The assets 141, 142 and 143 are applied to the time-series analytics to characterize the relationship between the fundamentals of the assets 141, 142 and 143. The fundamentals scores 145 of the various assets 141, 142 and 143 are analyzed 146 to determine the liquidity relations between the assets 146 using the fundamentals scores 145 and the system creates a search process to create potential portfolio 148.

In the fifth step, the assets 141, 142 and 143 are passed through a computer algorithm 150 which utilizes a time-series regression technique 151 to determine a liquidity relationship 152 based on a liquidity score 153.

In the sixth step 160, a series of potential portfolio 161, 162 and 163 generated by search process 148 are displayed to the client 164. Using an analytical tool 165, the client 164 can analyze the various potential portfolios 161, 162 and 163 to determine how the portfolios 161, 162 and 163 will react to certain liquidity events. The results are displayed to the client 164. The client 164 may choose 167 target a portfolio 161 based on his or her personal preference.

In the seventh step 170, the system shows the necessary steps to rebalance the current portfolio 171 to achieve the target portfolio 161 by displaying the rebalancing suggesting 172.

These are the assets that will be analyzed and considered for inclusion in the portfolio. Data analytics are used to characterize the relationship between assets. In the diagram, the relationship between the three assets is analyzed to see what relationships may exist between them. This process is repeated for liquidity relationships between assets. These results are used to create a mapping and search process for potential portfolios. This mapping process creates a map that can be used to guide and inform the search for potentially suitable portfolios for the client. Next, data analytics techniques are used to understand liquidity structures over time. These liquidity structures and the mapping-based search process creates potential portfolios for the client. In this example, three potential portfolios are found. The client is presented with these three potential portfolios, and in the example, the client chose the first portfolio as his or her target portfolio. This target portfolio is compared to his or her current portfolio, and the client is presented with rebalancing suggestions to restructure his or her assets to achieve the target allocation.

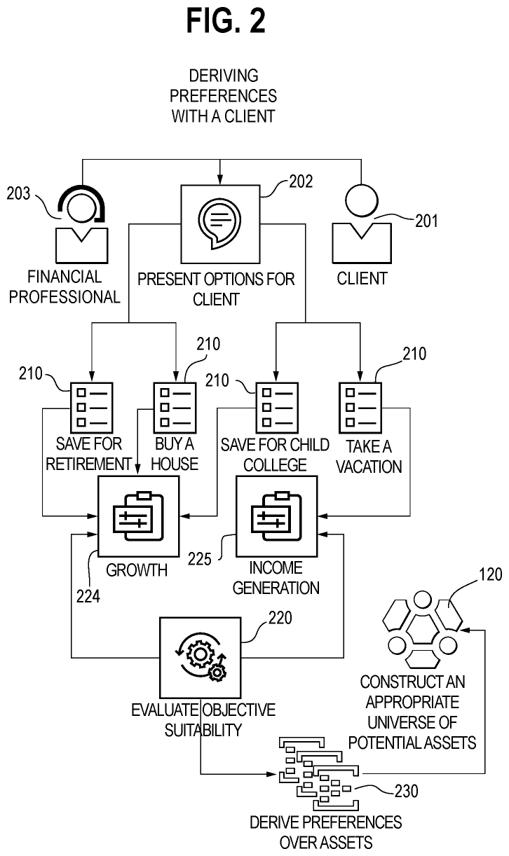

With reference to FIG. 2, the flow-chart diagram shows an example of the process used to derive preferences for a client 201. In this example, the financial professional begins by discussing the client's current finances and his or her investment goals. The client is presented with a list of options 202 for goals of the client 201. Based on the goals 210, a series of client preference scores 224 or 225 are generated for the particular clients 201 preferences 210. In the example, the client 203 would like to save for retirement 210, buy a house, help a child pay for college tuition in the future, and take a vacation. These four desires are the client's goals 210. The financial professional then discuss these goals in more detail to derive some objectives. For example, the client may be many years away from retiring, is several years away from buying a house, and has a young child that will not be enrolling in college for many years. The system assigns a client preference score 224 or 225 to a client based on the client goals 210. As such, the client's portfolio would be well-suited for assets that would grow over time 224, such as technology-based company stocks. The client 201 would be assigned the appropriate client preference score 224. In addition, to save for a vacation part of the portfolio could be allocated to income-generating stocks and bonds that can generate a stream of cash to help pay for a vacation in the future. In such case, the client 201 would also be assigned the appropriate client preference score 225. It is important to note that these objectives do not follow directly from the goals but are the result of a analysis on the goals. For example, if the client's child is in high school at the time, then growth-based investments may not be an appropriate vehicle for college savings. Likewise, the kind of income-generating investment may vary if the client wishes to take a vacation every year, every several years, or very rarely. In the example, saving for retirement, buying a house, and saving for a child's college expenses generate a liquidity preference score 224 objective of portfolio growth while the goal of taking a vacation generate a liquidity preference score 225 objective of income generation. Next, the system characterizes the trade-offs and desires regarding these sets of objectives as a group of preferences and evaluates what assets are appropriate and suitable for the client given his or her preferences. The liquidity preference scores 224 and 225 are used and compared with assets having an objective suitable score 220 for correlating to the liquidity preference scores. The assets 120 are categorized 230 based on the liquidity preference scores 224 and the objective suitability score of each asset from which an initial portfolio of assets is constructed 120. The end result is that these preferences derived from the client's objectives are used to determine what investments would be appropriate and suitable for the client. This set of appropriate investments is referred to as the universe of potential assets 120.

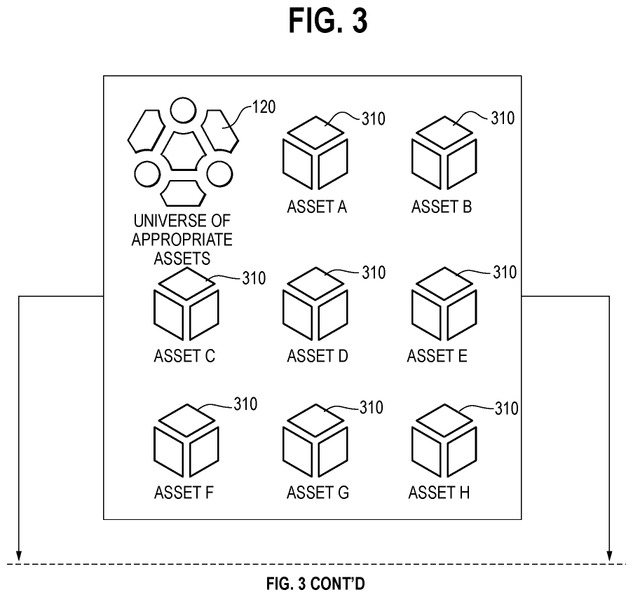

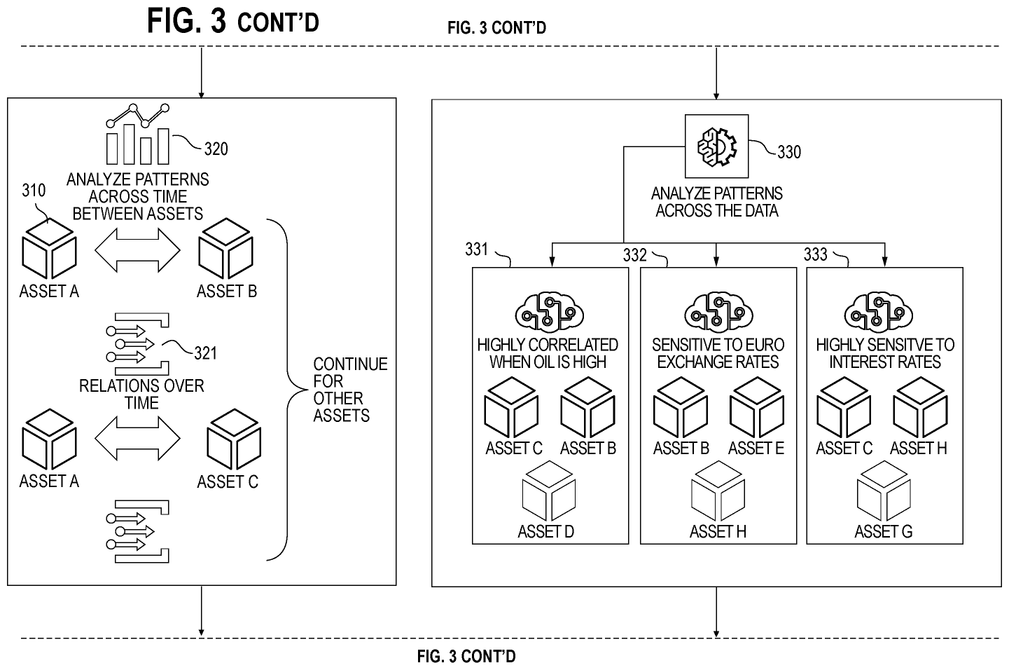

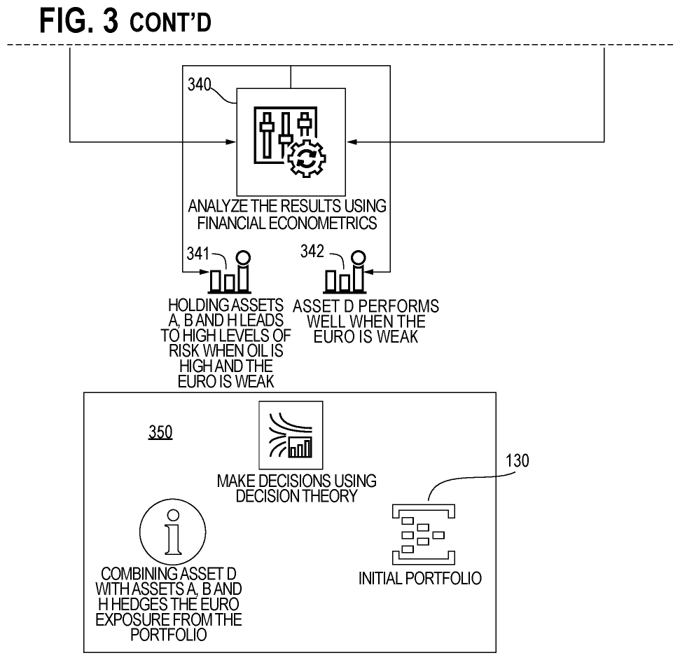

As shown in FIG. 3, the process of converting a universe of potential assets 120 to an initial portfolio 311 is explained. In the example, the universe of potential assets consists of 8 different assets 310: Assets A, B, C, D, E, F, G, and H (311). In reality, there are often many more assets under consideration, but this example is simplified. The data is then passed through two different data analytics procedures: time series analysis 320 and machine learning 330. The box on the left shows an example of the time series analysis process 320. Assets 310 are compared to each other to note trends and patterns across time 321. For example, the trading history of Asset A can be compared to Asset B, and Asset A can be compared to Asset C, and so on. More complex comparisons are often made as well, for example, by analyzing Asset A and Asset B added together compared to Asset C. These results are parsed and analyzed for trends over time. In the right box 330, machine learning is used to analyze trends across the entire data set. In the example, the analysis leads to three insights: that A, B, and D are highly correlated when the price of oil is high 331, that assets B, E, and H are sensitive to Euro exchange rates 332, and that assets C, H, and G are highly sensitive to interest rates 333. The results from the time series analysis and machine learning perspective are analyzed using financial econometrics 340 to infer insights into the data environment. In this case, two insights are revealed: that holding assets A, B, and H together is risky in an environment where both oil prices are high and the Euro is weak 341, and that Asset D performs well when the Euro is weak 342. While these insights are useful, they need to be implemented into a financial decision in the last step using decision theory 350. Decision theory, combined with the previous two insights, concludes that adding Asset D to the mix of A, B, and H is a useful hedge for a weak Euro, improving the portfolio mix. Decision theory 350 uses these insights to produce the initial portfolio 311.

FIG. 4 shows an example of asset linkages derived using time-series analysis 320 for an initial portfolio 311. The initial portfolio 311 from FIG. 3 consists of Assets A, B, D, and H is denoted in this figure and separated from the other assets by a box. These assets are then run through a time series algorithm 320 to detect relations and patterns over time. In this example, two relationships are examined: whether a company's tendency to grow 401 over time is influenced by other companies and whether an asset's tendency to present good value 402 to investors is influenced by other companies. In this simplified example, only one-way comparisons are shown, and only positive relationships (one company's growth increases another company's growth) are shown. In more complex analyses, it is not uncommon to see multi-factor considerations with positive and negative effects. Asset A (which is included in the initial portfolio) has a growth relationship with assets F and G. Asset A also has a Value relationship with Asset B. Asset B exhibits a Value relationship with Asset F and a value relationship with Asset E. Asset H's only relationship is a growth relationship with Asset D, while Asset D also has a growth relationship with Asset G. One can also note that Assets G and F, which are not included in the portfolio, each have two different relationships with assets outside the portfolio. In particular, Asset F has five different relationships with assets, many of which are not included in the portfolio. This suggests that Asset H tends to be highly unrelated to the assets in the rest of the portfolio, while asset F tends to have many dependencies. These relationships shed insight into what may occur as assets are added and removed from the portfolio and what assets are candidates for substitution. For example, Asset E would only possibly be a viable substitute for Asset B while Asset G could be a substitute for Assets A and D. If asset G was added to the portfolio, Asset F could also be a substitute for Asset G. The implication from this is that because assets may be moved in and out of the portfolio, the relationships between assets outside of the initial portfolio 120 may also become a material concern as assets are included and excluded from the selection.

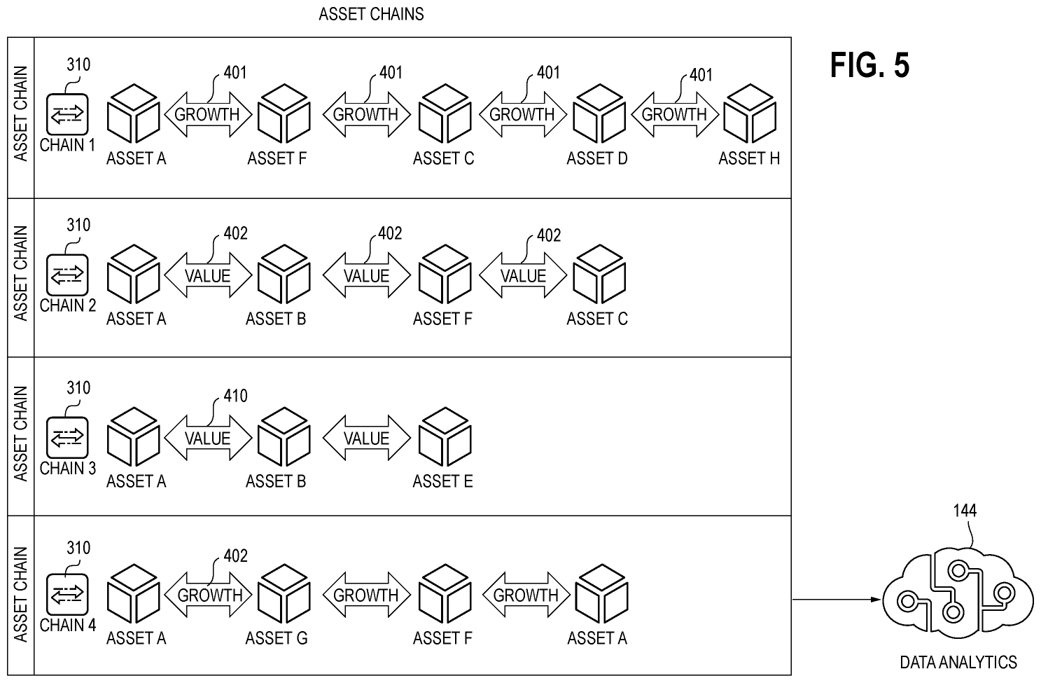

FIG. 5 shows an example of the construction of an asset chain from the results in FIG. 4. These chains are built based on linkages that can occur from the initial portfolio 120. In the included example, only four chains based on the results from FIG. 4 are included. In the first chain, Asset A has a growth relationship with Asset F, which has a growth relationship with Asset C, which has a growth relationship with Asset D, which has a growth relationship with Asset H. This chain has four links, beginning with Asset A and ending with Asset H. In the second chain, Asset A has a value relationship, or link, to Asset B which has a value link to Asset F which has a value link to Asset C. The second chain is similar in that it also begins with Asset A but considers a different linking criterion (value) and contains 3 links instead of 4. Chain 3 shows a Value link between Asset A, Asset B, and Asset E. This shorter chain shows that while some of the resulting chains may be very long, some may also be very short. The final chain shown is Chain 4. In Chain 4, Asset A is growth linked to Asset G which is growth linked to Asset F which is growth linked to Asset A. In this chain, the process starts and ends at Asset A. This demonstrates that chains can circle back onto themselves, and then propagate and transition across the asset topology. For example, Chain 4 could continue into Chain 1, or chain 4 could continue into Chain 4 again. This chain is a non-terminating chain, in that the final point of the chain is itself and could cycle and continue. In Chain 1, if the user began at Asset A and continued to Asset H, the chain would terminate, but if the chain began at Asset H and continued back to Asset 1, it could then cycle into Chain 4 and back into Chain 1 again. This example shows that these asset chains are multi-dimensional and reliant and dependent on other chains and relationships and can quickly become quite complex. In practice, with tens of thousands of assets under consideration, a high-computing environment built to handle, search and examine these different relationships becomes important. Key chains can be determined, using machine learning, that represent the most likely asset substitutions that should be prioritized for future research, leading to insights into which chains are the most important and which are less likely to lead to successful portfolios.

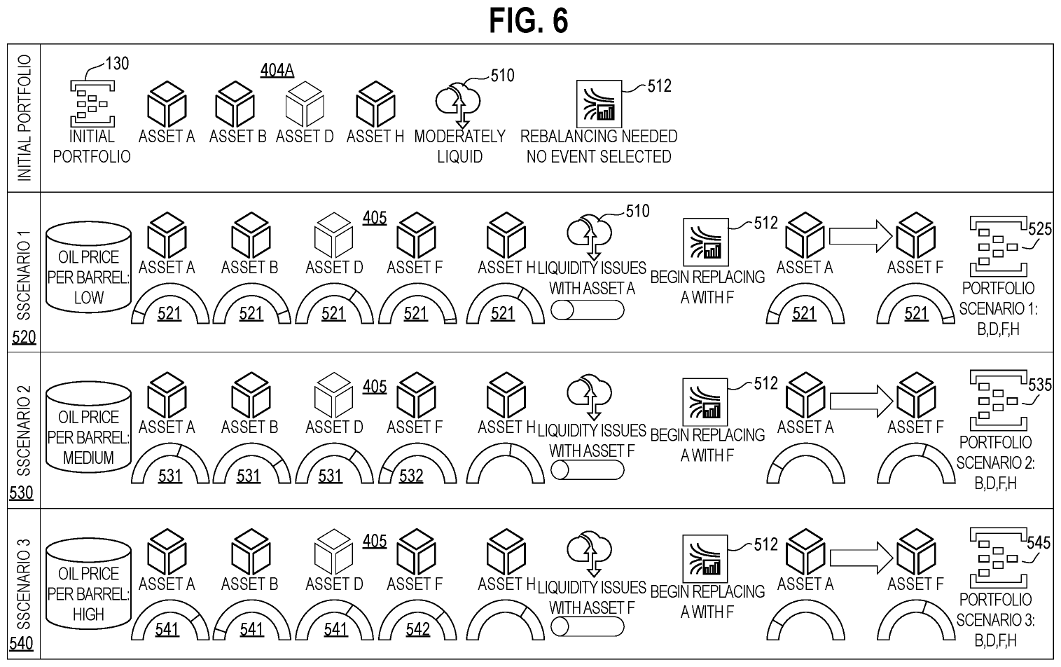

FIG. 6 shows an example of how portfolios can be adjusted, and liquidity analyzed in different states. In FIG. 6, there are four rows, one corresponding to the initial allocation 311 and three more rows for different scenarios 520, 530 and 540. In the first row 520, an initial allocation is shown. Consistent with the example in FIG. 3, the initial allocation 311 will be assets A, B, D, and H. The portfolio in current market conditions is fairly liquid. Next, consider the scenario when oil prices are low 520. This corresponds to the second row in FIG. 6. Below each asset is a blue bar showing how liquid each asset is. The liquidity analysis is used to generate different scenarios 520, 530 and 540 based on a hypothetical event. The assets 404 are provided a liquidity score 521 applied to the asset based on the results of the hypothetical event. New assets 405 may be introduced into the portfolio 311 in the scenarios 520, 530 and 531. Based upon the scenario presented in the hypothetical, the liquidity score of each asset 404 in the initial portfolio 311 and new assets 405 is analyzed to determine in any assets 404 and 405 liquidity score 521, 522 falls below a threshold liquidity score. If the liquidity score 521 or 522 of any asset 521 and 522 falls below a minimal threshold set by the system and the system recommends replacing the asset 404 (in this case asset A) with a new asset 405 that scores above a minimal threshold set by the system. The scenario portfolio 535 for scenario 1 is generated containing the assets 404 and 405 which score above the minimum threshold of the liquidity score 521. The scenario portfolio 535 provides a recommended action 512 to take should the scenario 520 occur. In this example, we will consider five assets: Assets A, B, D, F, and H. Recall that FIG. 4 showed that Asset F was a good candidate as an alternative, and several chains were using asset F in FIG. 5.

FIG. 6 shows how these chains can be used in an example. Below each asset in row 2 is a scoring system 521, 531 and 541 to measure how liquid the asset is in the scenario. In the scoring example shown, the fuller the bar, the more liquid the asset is. In this example, Asset A 404 is very illiquid as denoted by the mostly empty bar 521, while Asset F 405 is highly liquid 522. Recall that FIG. 5 showed that F is a possible substitute for Asset A. The liquidity analysis, as denoted by the cloud-shaped figure with arrows, shows that Asset A is leading to liquidity issues. The decision theory 512 suggestion recommends slowly replacing Asset A with F in this scenario. This leads to the target portfolio 525 in scenario 1: Assets B, D, F, and H.

In scenario 2, shown as 530, there are liquidity issues with asset F 532. Similar to scenario 1, Asset F 405 is a possible replacement for Asset A 404, so the decision theory suggestion is to start replacing positions in Asset A with Asset F. This leads to a portfolio scenario 535 of Assets F, B, D, and H. It is important to note that if one begins with the initial portfolio no rebalancing or changing of positions is necessary. However, suppose that one was in a low oil price environment and held some of Asset F. As oil prices rise, this analysis would suggest that one would then begin transitioning from holding F to A. As such, one could think of these scenarios as a spectrum and as oil prices move from low to medium positions in asset F are replaced with asset A.

In scenario 3, shown as 540, there are severe liquidity issues with Asset B 541. To correct for this, the decision theory analysis suggests substituting some of Asset B 404 with Asset F 405. This final row shows that some of the liquidity effects are not linear. For example, Asset F has liquidity issues when oil prices are moderate, but not when prices are low or high. High volatility in oil prices could lead to events such as where Assets A, B, and F are dynamically shifted, and some scenarios where A and B are swapped as well. This is because these changes to meet the target portfolio often happen slowly over time. If oil prices change rapidly, the rebalancing and restructuring can be quite complex.

It is worth noting that the portfolio recommendations 512 can be proactive. For example, an investor may want to hedge from liquidity issues in high oil price environments and may proactively move some holdings from Asset B to Asset F. When deciding whether to take proactive steps, it is important to consider the likelihood of these different scenarios or scenarios like them occurring. As such, to make inferences about how likely different scenarios are to occur, it can be helpful to use Markov Chain Monte Carlo to understand how likely different events are to occur and how they might occur, leading insight to how a portfolio might need to be rebalanced. The example in the figure shows the type of scenarios that may be investigated by such a search process.

FIG. 7 shows an example of an MCMC driven search process 148. In this example, there are three scenarios 510, 520 and 530, two regions 540, 550, and many different potential portfolios 570 for clients. In the search process, the MCMC algorithm 148 searches across the potential portfolios 570 for candidates that could be a good fit. The process begins the search at a starting portfolio 580 and then checks a nearby portfolio 570 to see if it would be a good fit. The line with a “1” denotes the first transition to a new portfolio to check. Based on the results from checking the portfolio 570, it gives the search algorithm insight into the next portfolio 571 to investigate. Each number indicates the order in which a portfolio is investigated to demonstrate how the chain moves and explores potential portfolios 571, 572, 573, 574, 575, 576, 577, 578, 579. The second 571 and third 572 portfolios investigated perform very well in a certain kind of scenario 510, 520 and 530. A “Scenario” icon is present near these portfolios. This means that these should be considered as possible allocation targets under specific conditions. In the example, the search process continues and eventually enters region 1 550. Machine learning algorithms are used to detect and classify regions 550, 540 of allocations with similar characteristics. The search algorithm 148 investigates some portfolios 572, 573 in this region 530 but quickly transitions out. This means that these portfolios tended to be poor candidates and that portfolios 572, 573 in this region are highly unlikely to be suitable candidates for the client. As such, this is denoted in the example as a “Low Traffic Region,” as very few portfolios from this region will be investigated and the search process will tend to avoid this region. Due to the complex and multi-dimensional nature of the search process, if the search progresses for long enough on occasion, the process will re-visit these regions but will usually transition out and explore other regions quickly. Eventually, the search process continues and enters region 2 (540). Unlike region 1 (550), many of the portfolios 579, 581, 582, 583, 584 in region 2 (540) appear to have desirable features that the client wants, causing the algorithm 148 to spend more time in this region. Many of the portfolios 579, 580, 581, 582, 583, 584 in region 2 (540) are analyzed, and the search algorithm 148 spends more time in this space before transitioning out. As the search continues, the algorithm 148 is very likely to return to region 2 (540) and spend time searching there. This region is therefore classified as a “High Traffic Region.” The determination of which region 550, 540 to search and how appealing a certain region is updates as the search is run based on the characteristics of the portfolios detected in each region in concert with the earlier machine learning classification results. As such, the earlier machine learning overlay is run through a Bayesian updating process with the new results from the ongoing search.

The example above shows a simplified process. There are ways to increase the efficiency of the selection process. For example, with a multi-core computer processor, multiple searches can occur in general. In general, this process is designed to use different kinds of processors for different kinds of tasks based on efficiency. Multi-Core CPU processors running in a parallel computing environment are optimized for many computations that do not require matrix manipulations or machine learning methods. Analysis methods such as Markov Chain Monte Carlo are typically more efficient with GPU processors, and as such these are utilized when performing analysis that is matrix-heavy, machine learning based, or more efficient in a GPU environment such as Markov Chain Monte Carlo.

These searches tend to be complex and are not straightforward and require careful planning. For example, one consideration is the trade-off between specificity and breadth. In a broad search, the search algorithm 148 will explore many possible regions for potential portfolios. When using this kind of process, the algorithm will explore more of the space of potential portfolios and can pick up details and complexities that could be missed by a narrow search. In the previous example, a broad search would spend more time in region 1 (550) and less time in region 2 (540). However, this means investigating lots of portfolios that will be poor fits. In a less broad and more specific search, the algorithm will spend more time in regions that are good fits and will transition out of these spaces less often. In the previous example, the search algorithm would spend very little time in region 1 (550), would very infrequently search the region, and would spend a great deal of time searching in region 2 (540). In this search, when the algorithm begins exploring region 2 (540), it would stay and continue to explore the region for quite some time before transitioning out. A search with high specificity will focus on and find portfolios that tend to be good fits for the client. However, these portfolios will tend to be very similar to each other, and large swathes of the portfolio topology will remain unexplored. These two approaches—a broad or specific search—are two ends of the search spectrum, and the search process can be parameterized to be more specific or broader. The parameterization can be non-trivial as different searches have different trade-offs and the optimal search depends on a multitude of factors, such as the amount of time allocated for the search, the number and computational power of the processors allocated, how complex and broad the search space is the complexity of the client's desires and many other factors.

FIG. 8 depicts an example of portfolio rebalancing suggestions 600. The example contains 6 rows corresponding to a header 610 and 5 suggested steps to rebalance a portfolio. There are 5 columns, corresponding to the current portfolio position, the rebalancing suggestion, the target position, the priority of the transaction, and the severity of the transaction.

The second row 611 contains the first suggested rebalancing transaction. The first column in row 2 contains Asset 1, the rebalancing suggestion in row 2 column 2 contains an arrow, and row 2 column 3 contains Asset 2. The black arrow indicates that the rebalancing step involves selling Asset 1 and buying Asset 2, in effect converting the holdings and position in Asset 1 into a position in Asset 2. In row 2 (611), column 4, the number 1 indicates this is the highest priority transaction with priority 1. The fifth column contains an indicator showing that this is a high priority transaction that should be executed immediately or very soon. This column adds context to the results from column 4, showing how important the transaction is to the structure of the portfolio. In a well-structured portfolio, there will be many low priority transactions, while a poorly balanced portfolio will have many high-priority changes. The third row 612 is similar to the second 611, denoting a transaction of moving asset 3 into asset 4. The number 2 denotes the 2^{nd} priority transaction which is also high priority. Unlike the previous two transactions, the transaction in row 4 (613) is medium priority. These transactions are not as urgent but should still be undertaken when market conditions are appropriate. The fifth column 614 shows a low priority transaction. These transactions are not urgent but are still worth enacting when conditions are favorable. The final transaction 615 in row 6 is very low priority. These are actions that can be taken by the portfolio manager, but generally can be avoided and should not be taken if there are significant transaction fees.

The portfolio rebalancer updates in real-time and will suggest new positions as markets and conditions change. This example illustrates how an investor can make rebalancing decisions and change portfolio positions based on real-time data with feedback from the proposed innovation.

It is to be understood that the figures and descriptions of the present invention have been simplified to illustrate elements that are relevant for a clear understanding of the present invention, while eliminating, for the purpose of clarity, many other elements found in a typical system. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Some portions of above description describe the embodiments in terms of algorithms and symbolic representations of operations on information. These algorithmic descriptions and representations may be used by those skilled in the data processing arts to convey the substance of the work effectively to others skilled in the art. These operations, while described functionally, computationally, or logically, are understood to be implemented by computer programs or equivalent electrical circuits, microcode, or the like. The steps described are complete and impossible to be performed by a human. Furthermore, it has also proven convenient at times, to refer to these arrangements of operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for generating reports based on instrumented software through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A computer-implemented method of performing an analysis of a liquidity preference, recommending a portfolio of one or more assets based upon the liquidity preference and rebalancing the portfolio of assets based on hypothetical future scenarios, the method comprising:
generating a database containing data related to a preference wherein said preference relates to liquidity risk and converting the preference to a machine-readable graphic interface to present a user;
generating within said database a client preference metric for each asset in a group of one or more assets, assigning a liquidity preference metric to each of the assets;
presenting a preference to a user, wherein the user provides a response to the preference;
extracting material information from the response to the preference and generating a client preference score based on the material information extracted from the preferences;
to construct an initial portfolio by comparing the client preference score to the liquidity preference metric assigned to each of the assets and selecting assets that correspond to the client preference score;
passing the assets in the initial portfolio of assets through a non-transitory computer readable medium analytics fundamental algorithm having stored therein instructions executable by a processor whereby the fundamental algorithm creates a fundamental characteristic for an asset based on characterizing the fundamental relationship score of the assets in the initial portfolio, the algorithm utilizes a time-series analysis to evaluate a fundamental relationship of the assets over time, establishing a nuanced fundamental link between the assets in the initial portfolio and assets stored in the database using the metric for each asset;
selecting an asset that correlates to the fundamental characteristics;
passing the selected asset that correlates to the fundamental characteristics in the initial portfolio of assets through a non-transitory computer readable medium analytics liquidity algorithm having stored therein instructions executable by a processor whereby the liquidity algorithm creates scenarios for a predetermined future event and deconstructs the nuanced fundamental link by implementing a time-series regression technique to generate a scenario-based liquidity score and to measure a liquidity relationship based upon the liquidity score of the assets in the initial portfolio and the scenario-based liquidity score;
selecting an action to replace an asset in the initial portfolio with an asset from the database of assets based on the nuance fundamental link and the scenario-based liquidity score; and
displaying the selected action to replace the asset in the initial portfolio with an asset from the database of assets to the user.

2. The computer-implemented method of performing an analysis of a liquidity preference, recommending a portfolio of one or more assets based upon the liquidity preference and rebalancing the portfolio of assets based on a hypothetical future scenario of claim 1, wherein the fundamental algorithm determines a lagged relationship between assets in the initial portfolio by generating a lagged factor utilizing a time-series cointegration analytic technique.

3. The computer-implemented method of performing an analysis of a liquidity preference, recommending a portfolio of one or more assets based upon the liquidity preference and rebalancing the portfolio of assets based on a hypothetical future scenario of claim 1, wherein the fundamental algorithm determines a lagged relationship between assets in the initial portfolio by generating a lagged factor utilizing a time-series spectral decomposition technique.

4. The computer-implemented method of performing an analysis of a liquidity preference, recommending a portfolio of one or more assets based upon the liquidity preference and rebalancing the portfolio of assets based on a hypothetical future scenario of claim 2, further comprising the step of utilizing a time-series spectral decomposition technique to determine the lagged factor.

5. The computer-implemented method of performing an analysis of a liquidity preference, recommending a portfolio of one or more assets based upon the liquidity preference and rebalancing the portfolio of assets based on a hypothetical future scenario of claim 1, wherein the fundamental linkages between assets are deconstructed to score a liquidity link and pattern using time-series econometrics.

6. The computer-implemented method of performing an analysis of a liquidity preference, recommending a portfolio of one or more assets based upon the liquidity preference and rebalancing the portfolio of assets based on a hypothetical future scenario of claim 4, wherein the fundamental linkages between assets are deconstructed to score a liquidity link and pattern using time-series econometrics.

7. The computer-implemented method of performing an analysis of a liquidity preference, recommending a portfolio of one or more assets based upon the liquidity preference and rebalancing the portfolio of assets based on a hypothetical future scenario of claim 1, further comprising the step of dynamically searching the nuanced fundamental link and exploring a liquidity event over time.

8. The computer-implemented method of performing an analysis of a liquidity preference, recommending a portfolio of one or more assets based upon the liquidity preference and rebalancing the portfolio of assets based on a hypothetical future scenario of claim 5, further comprising the step of running time-series regression on the assets of the initial portfolio to determine what lagged factors impact liquidity at specific time periods in the scenario.

9. The computer-implemented method of performing an analysis of a liquidity preference, recommending a portfolio of one or more assets based upon the liquidity preference and rebalancing the portfolio of assets based on a hypothetical future scenario of claim 1, wherein the liquidity algorithm utilizes a time-series regression technique to determine a liquidity event based upon the client preference score and generating a liquidity event score for the assets based on the scenario.

10. The computer-implemented method of performing an analysis of a liquidity preference, recommending a portfolio of one or more assets based upon the liquidity preference and rebalancing the portfolio of assets based on a hypothetical future scenario of claim 9, wherein the time-series regression technique is combined with game theory models to describe preference and behavior patterns of an investor to create certain conditions for the scenario based on the liquidity event score.

11. The computer-implemented method of performing an analysis of a liquidity preference, recommending a portfolio of one or more assets based upon the liquidity preference and rebalancing the portfolio of assets based on a hypothetical future scenario of claim 10, wherein the time-series regression model is developed using relational topology structures based on the liquidity event score.

12. The computer-implemented method of performing an analysis of a liquidity preference, recommending a portfolio of one or more assets based upon the liquidity preference and rebalancing the portfolio of assets based on a hypothetical future scenario of claim 1, wherein the nuanced fundamental link and scenario-based liquidity score are generated utilizing a real-time cloud computing-based machine learning approach combined with an optimizer.

13. The computer-implemented method of performing an analysis of a liquidity preference, recommending a portfolio of one or more assets based upon the liquidity preference and rebalancing the portfolio of assets based on a hypothetical future scenario of claim 1, wherein the fundamental link and scenario-based liquidity score are generated utilizing a Markov Chain Monte Carlo technique.

14. The computer-implemented method of performing an analysis of a liquidity preference, recommending a portfolio of one or more assets based upon the liquidity preference and rebalancing the portfolio of assets based on a hypothetical future scenario, the method comprising:
creating a database of assets, assigning each asset a liquidity preference metric and generating a preferences database of client preference scores based upon a response to a series of preference questions provided to a client;
generating the series of preference questions and the response into a machine-readable graphic interface and presenting the series of preference questions to a user wherein said user generates a response;
creating a client preference score for the user from the database based upon the responses of the user from the series of preference questions;
searching the database of assets based on the client preference score and generating a universe of assets based on the liquidity preference metric which correlate to the client preference score of the user, and constructing an initial portfolio of assets;
applying a time-series analytical technique to the initial portfolio of assets to determine a fundamentals relationship of the assets to discover a related asset and applying a fundamentals value to the related assets;
passing the assets in the initial portfolio through an algorithm utilizing a time-series regression technique to determine a liquidity relationship based on a liquidity score of the assets;
applying a time-series analytical technique to the fundamental value of the related assets to discover a liquidity relation between the assets and creating a search process to create potential portfolios;
generating a plurality of scenario portfolios based on the created search process;
displaying the plurality of scenario portfolios containing a scenario of assets to the user via a user interface; and
presenting analytical tools to a user to permit the user to analyze the plurality of scenario portfolios to determine how the scenario assets in the scenario portfolios will react to a liquidity event.

15. The computer-implemented method of performing an analysis of a liquidity preference, recommending a portfolio of one or more assets based upon the liquidity preference and rebalancing the portfolio of assets based on a hypothetical future scenario of claim 14, further comprising the step of permitting the user the choice of selecting one of the plurality of scenario portfolios and, upon selection of the scenario portfolio, displaying the steps necessary to rebalance the assets in the initial portfolio to the scenario portfolio.

16. The computer-implemented method of performing an analysis of a liquidity preference, recommending a portfolio of one or more assets based upon the liquidity preference and rebalancing the portfolio of assets based on a hypothetical future scenario of claim 15, further comprising the step of conducting a time-series analytics procedure and machine learning analytics procedure.

17. The computer-implemented method of performing an analysis of a liquidity preference, recommending a portfolio of one or more assets based upon the liquidity preference and rebalancing the portfolio of assets based on a hypothetical future scenario of claim 14, further including the step of generating a plurality of regions based on liquidity risk and applying a Markov Chain Monte Carlo on the plurality of regions to measure the fundamentals relationship and liquidity relationships of the assets in a portfolio.

18. The computer-implemented method of performing an analysis of a liquidity preference, recommending a portfolio of one or more assets based upon the liquidity preference and rebalancing the portfolio of assets based on a hypothetical future scenario of claim 17, wherein the Markov Chain Monte Carlo procedure utilizes a plurality of scenarios to perform a plurality of iterative runs over the regions and search for optimal allocations and solutions for different types of liquidity preferences of a portfolio.

19. The computer-implemented method of performing an analysis of a liquidity preference, recommending a portfolio of one or more assets based upon the liquidity preference and rebalancing the portfolio of assets based on a hypothetical future scenario of claim 18, further including the step of operating a machine learning technique to categorize a topological space and mark a region based on liquidity risk.

20. The computer-implemented method of performing an analysis of a liquidity preference, recommending a portfolio of one or more assets based upon the liquidity preference and rebalancing the portfolio of assets based on a hypothetical future scenario of claim 19, further comprising the step of implementing game theory techniques to a categorized topological space within the plurality of regions to identify a space that will lead to a liquidity hedge.
